(19) United States
(12) Patent Application Publication
(10) Pub. No.: US 2008/0275974 A1
(43) Pub. Date: Nov. 6, 2008

(54) System, method, and display for managing media content for use at multiple locations

(75) Inventor: Nathaniel Vincent Rackiewicz, Hoboken, NJ (US)

Correspondence Address: KENYON & KENYON LLP, ONE BROADWAY, NEW YORK, NY, 10004, US

(73) Assignee: Home Box Office, Inc.

(21) Appl. No.: 11/799,928

(22) Filed: May 2, 2007

(51) Int. Cl. G06F 15/173

(52) U.S. Cl. 709/223

(57) ABSTRACT

In a system and method for managing user profiles and for managing, recording, and experiencing media content, a server may store a profile, content, and an association of the content with a profile, each of multiple devices may log into the profile by accessing the profile stored at the server, and, for the profile into which the device is logged, transmit to the server a content request, for example, periodically, and the server may, responsive to the content request, determine which content stored at the server is associated with the profile and transmit to the device a copy of the content that has been determined to be associated with the profile. The content may be stored at the server in association with the profile before the device is associated with the profile.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates to a system, method, and display for managing and/or distributing media content.

### BACKGROUND INFORMATION

Media content providers, such as television (TV) and/or audio providers, transmit media content to many users. However, different viewers have different taste. Therefore, not all of the media content are of interest to each of the users to whom the media content are transmitted. Users scan received media content in search of particular content units, e.g., TV programs, of the received content to view or otherwise experience. For example, users tune their TVs to different channels in search of the particular channel of most interest. Alternatively, users scroll through media content menu displays in search of the media content of interest.

The menu displays often include a schedule indicating media content that will be made available at a later time. Users can plan to dedicate future blocks of time to particular media content that the schedule indicates will be later made available. Further, users' receiving devices, e.g., set-top boxes in communication with respective TVs, are often equipped with recording devices, e.g., digital video recording devices (DVRs) so that, if a program is scheduled at a time that conflicts with a user's other planned activities, the user can interact with the schedule by inputting instructions to the set-top box, for example, via a remote control device, instructing the set-top box to record to local storage the media content while it is broadcast for viewing or experiencing at a different time than the scheduled time.

Sometimes, a user must navigate through descriptions of hundreds of programs presented on various channels until the user finds a program of interest. Further, amongst the program descriptions dismissed by the user as uninteresting to the user, there are often descriptions of programs which, contrary to the user's determination, would be of interest to the user. For example, the description may be somewhat misleading in certain respects, e.g., by failing to describe certain features of the program which interest the user. Additionally, some programs are units of a program series that are periodically, e.g., weekly, provided. If the user determines that the program is of interest, it is inefficient for the user to repeatedly check the schedule to determine or recall the time at which it will be next provided, or to repeatedly indicate for each unit of the series that the unit should be recorded.

A set-top box is therefore programmed to store profiles for one or more regular users of the set-top box, e.g., users associated with an account with which the set-top box is associated. A profile is set up by a user and/or automatically based on the user's media content experience habits and/or based on another entity's, e.g., a service provider's, preferences. The profile indicates media content preferences, such as favorite TV programs or favorite TV program types; recording preferences; and/or media content limitations, such as parental restrictions. The profile is used for providing a media content schedule tailored to the user associated with the profile. The profile is also used for recording media content to be delivered in the future. For example, the profile may indicate that all TV programs of a particular series are to be recorded. Based on this indication and based on received schedules, e.g., that are periodically updated, the set-top box determines the times at which the TV programs of the indicated series will be shown and automatically records the TV programs.

However, users often travel to various locations, for example, to friends' and relatives' homes or to hotels. Transporting the user's set-top box to each location the user visits and, each time, connecting the set-top box to the local wiring system is impractical. The user therefore loses the benefits provided by the set-top box profile, and is resigned to inefficiently scanning the menu of provided media content and manually indicating each particular media content the user wishes to experience.

### SUMMARY

Embodiments of the present invention provide for efficient management and/or sharing of a user profile by multiple devices. Embodiments of the present invention provide a system, method, and display for managing media content (including, e.g., moving images such as TV programs) via centrally stored portable profiles into which a user may log at any device capable of accessing, processing, and outputting data for applying the profile's settings, such as recording preferences, parental controls, and/or tailored content schedules, to the device. Embodiments of the present invention provide for inputting at a first device and via a profile associated with the first device an instruction to have content recorded, recording the content in accordance with the instruction, and experiencing, e.g., viewing, the content at a second device associated with the profile. Embodiments of the present invention provide for setting up at a first device a new profile that is not associated with any device, and subsequently logging into the newly set up profile at a second device thereby associating the newly set up profile with the new device. Once the profile is associated with the second device, the second device may download media content centrally stored (or stored at the first device or other device) based on the profile and may record the downloaded media content to local storage.

According to an example embodiment of the present invention, a method for recording content may provide for: in accordance with a recording schedule of a profile, storing content at a server and storing at the server an association of the content with the profile; and, responsive to a content request from a first device associated with the profile, the server determining which content stored at the server is associated with the profile and transmitting to the first device a copy of the content that has been determined to be associated with the profile.

In one example embodiment of the method, the method may further provide for the first device transmitting the content request at predetermined intervals and/or in response to one or more predetermined events.

In one example variant of this embodiment, the method may further provide for associating the first device with the profile. The first device may transmit the content request in response to a first one of the predetermined events, which is a provision of an indication of the performance of the association of the first device with the profile.

In one example variant of this embodiment, the association of the first device with the profile and the provision of the indication may be performed by logging into the profile at the first device.

In one example variant of this embodiment, the first device may transmit the content request also in response to a second one of the predetermined events, which is a power-up of the first device after association of the first device with the profile.

In one example embodiment of the method, the server may record a single copy of a particular content for each of a plurality of profiles that each indicates that the particular content is to be recorded.

In one example variant of this embodiment, the method may further provide for associating the single copy of the particular content with each of the plurality of profiles.

In one example variant of this embodiment, the method may further provide for: storing tracking information indicating for which of the plurality of profiles to which a respective copy of the single copy of the particular content is to be provided; for each of the plurality of profiles to which the respective copies are to be provided, updating the tracking information to indicate that the respective copy has been provided in response to transmission of the respective to at least one device associated with the respective profile; from the tracking information, determining whether any profile remains to which a respective copy of the single copy is yet to be provided; and deleting the single copy from the server responsive to a determination that the respective copies of all of the plurality of profiles have been provided.

In one example variant of this embodiment, the server may be associated with one or more of the plurality of profiles. Where the server is associated with the profile(s), the tracking information may maintain an indication that the single copy is to remain stored at the server for one of the one or more profiles even after the server transmits the respective copy of the single copy for the profile.

In one example embodiment of the method, the method may further provide for determining whether the content that is stored at the server and that has been determined to be associated with the profile has also been stored at the first device. The copy may be transmitted conditional upon a determination that the content that is stored at the server and that has been determined to be associated with the profile has not been stored at the first device.

In one example variant of this embodiment, the method may further provide for, responsive to receipt from a content provider and by the first device of broadcast content indicated by the recording schedule to be recorded, storing the received content at the first device.

In one example embodiment of the method, the method may further provide for transmitting the content from a second device to the server, and transmitting from the second device to the server an instruction updating the recording schedule and indicating that the content transmitted by the second device is to be associated with the profile. The storing of the content and the association at the server may be in accordance with the instruction.

In one example variant of this embodiment, the profile may remain unassociated with any device when the instruction is transmitted.

In one example embodiment of the method, the content stored at the server may include a moving image received by the server via a television tuner.

In one example variant of this embodiment, the content may further include an audio file, a still image file, and content of an RSS feed.

According to an example embodiment of the present invention, a method for managing recording of content may provide for: logging into a first profile; setting a recording preference for a second profile; and subsequent to the setting, logging into the second profile at a device to apply the recording preferences of the second profile at the device. The logging into the first profile may provide access to perform the setting.

According to an example embodiment of the present invention, a method for recording content may provide for: at a first device, creating a user profile including a recording schedule and unassociated with any device; transmitting the user profile to a server; and logging into the user profile at the first device or a second device to associate the logged device with the user profile. The logged device is configured to, responsive to the association of the logged device with the user profile, poll the server for content stored at the server in association with the user profile. The server is configured to store content in association with the user profile in accordance with the recording schedule and transmit the stored content to the logged device in response to a poll from the logged device.

According to an example embodiment of the present invention, a computer-readable medium may have stored thereon instructions adapted to be executed by a processor, the instructions which, when executed, cause the processor to perform a method for recording content, which method may provide for: (a) in accordance with at least one profile's recording schedule: storing content; and storing associations of respective portions of the content with respective ones of the at least one profile; (b) responsive to a content request from a device associated with a particular one of the at least one profile, determining which of the stored content is associated with the particular profile; and (c) transmitting a copy of the content determined to be associated with the particular profile to the device.

According to an example embodiment of the present invention, a system for recording content may include: a content experiencing device associated with a profile and a server. The content experiencing device may be configured to transmit a content request to the server. The server may be configured to: (a) in accordance with a recording schedule of the profile, store content and store an association of the content with the profile; and (b) responsive to the content request, determine which content stored at the server is associated with the profile and transmit to the content experiencing device a copy of the content that has been determined to be associated with the profile.

In one example embodiment of the system, the content experiencing device may be associated with a plurality of profiles in association with which the server stores content.

In one example embodiment of the system, the content experiencing device may be associated with the profile by logging into the profile at the content experiencing device.

In one example variant of this embodiment, the content experiencing device may include a television, a set-top box, and a memory for storing the copy of the content.

In one example variant of this embodiment, the server may include a television, a set-top box, and a memory in which the content and the association of the content with the profile is stored.

In one example variant of this embodiment, the server's memory may store a plurality of profiles including the profile with which the content experiencing device is associated. For logging into the profile, the content experiencing device may be configured to transmit user input profile information to the server, and the server may be configured to: determine whether the user input profile information matches corresponding information of the profile stored in the server's memory; and, conditional upon that the server determines that the user input profile information matches the corresponding information, transmit data to the content experiencing device for opening a profile session at the content experiencing device during which the content experiencing device transmits the content request in association with the profile.

According to an example embodiment of the present invention, a display method for managing content may provide for displaying a user-interactive screen for a managing profile. The managing profile may include information that regards a media management customer account and that is updatable by user interaction with screens including the user-interactive screen displayed for the managing profile. The user-interactive screen may include a plurality of first tabs, each of which is associated with a respective one of a plurality of user media preference profiles, and one of which is an active tab, and, for the active tab, (a) a listing of at least one of recording preferences and recorded content associated with the user media preference profile of the active tab, the listing updatable by user interaction with the listing, and (b) an input field for user input indicating one or more recording devices to be associated with the user media preference profile of the active tab.

In one example embodiment of the display method, the user-interactive screen may further include a second tab, selection of which is interpreted by a processor as an instruction to generate a new media preference profile.

In one example embodiment of the display method, the user-interactive screen and/or a second screen displayed in response to selection of a sub-menu of the user media preference profile of the active tab may include for the active tab a selectable graphical unit, selection of which may be interpreted by a processor as an instruction to upload locally stored content to a server for storage at the server in association with one of the plurality of user media preference profiles.

In one example embodiment of the display method, the listing may include a plurality of sub-listings. Each sub-listing may be of a respective one of a plurality of media content types. Each of the plurality of sub-listings may be separately displayed in the user-interactive screen.

In one example variant of this embodiment, the plurality of media content types may include at least two of the following: a video content type, an audio content type, and a still image content type.

According to an example embodiment of the present invention, a method for applying a media content profile to devices may provide for, for a single profile stored at a central storage device and including at least one media content setting, each of a plurality of devices: transmitting log-in information associated with the profile; and responsive to receipt of information transmitted by the central storage device in response to the transmitted log-in information, applying to the device a media content setting of the profile indicated in the received information.

In one example embodiment of the method, the media content setting(s) may include a parental control, a recording preference, a media content experience preference, a media content provider setting, and/or a communications medium setting.

In one example embodiment of the method, the method may further provide for each of the plurality of devices scheduling a time for recording media content based on the media content setting.

In one example embodiment of the method, the method may further provide for: at least one of the plurality of devices, while logged into the profile, requesting the central storage device to determine which media content is stored at the central storage device in association with the profile and to transmit to the requesting device at least a portion of the determined media content, the portion including all of the determined media content that is not stored at the requesting device at the time of the request; and storing at the requesting device all media content received from the central storage device in response to the request.

According to an example embodiment of the present invention, a method may provide for: storing at a central storage device a profile including at least one media content setting; and, for application of the at least one content setting to each of a plurality of accessing devices that accesses the central storage location for logging into the profile, transmitting the at least one media content setting to each of the plurality of accessing devices in response to the logging into the profile by the accessing device.

In one example embodiment of the method, the method may further provide for at least one of the plurality of accessing devices periodically polling the central storage location for updates to the profile.

According to an example embodiment of the present invention, a method of sharing a profile by a plurality of devices may provide for: storing, at a central location, a profile, the profile including device settings of a user; accessing, by a first one of the plurality of devices, the profile; recording content by the first one of the plurality of devices as a function of the profile; accessing, by a second one of the plurality of devices, the profile; and recording content by the second one of the plurality of devices as a function of the profile.

In one example embodiment of the method, the central location may be at a location that is remote to both the first and second ones of the plurality of devices.

### BRIEF DESCRIPTION OF THE DRAWINGS

FIG. 1 is a diagram illustrating components of a system for central storage of profiles at a remote server for access at local devices, according to an example embodiment of the present invention.

FIG. 2 is a diagram illustrating components of a system for central storage of profiles and content at a remote server for access at local devices, according to an example embodiment of the present invention.

FIG. 3 is a block diagram illustrating relationships between user profiles and local recording devices, according to an example embodiment of the present invention.

FIG. 4 is a screenshot of a selected tab corresponding to a profile, according to an example embodiment of the present invention.

FIG. 5 is a screenshot of a selected tab corresponding to a content type, according to an example embodiment of the present invention.

FIG. 6 is a cross-functional flowchart illustrating a content recordation and management method, according to an example embodiment of the present invention.

FIG. 7 is a cross-functional flowchart illustrating a content recordation and management method, according to an alternative example embodiment of the present invention.

### DETAILED DESCRIPTION OF EXAMPLE EMBODIMENTS

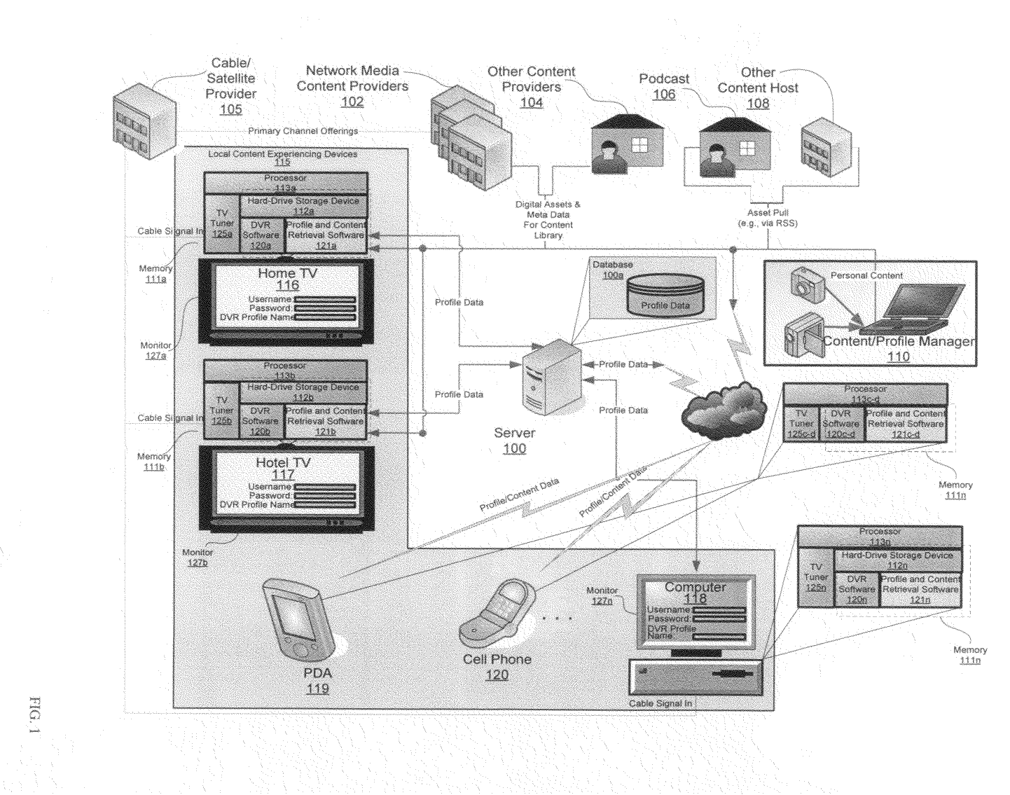

FIG. 1 illustrates components of a system according to an example embodiment of the present invention in which profiles are centrally stored for access by multiple devices. A server 100 may centrally store one or more user profiles. Profile data may be stored in a database 100a. The profiles may indicate media experience preferences, such as favorite program genres, parental controls, recording preferences, etc. Further, different profiles may be associated with different ones of a plurality of media providers. For example, a first profile may be associated with a cable provider 105, a second profile with a satellite provider, and yet another profile with another provider, e.g., a telephone company or other digital media provider. Different providers 105 may provide different content, and, even with respect to the same content, may provide the content on different channels. For example, while one provider 105 might provide the YES Network on channel 70, another provider 105 may provide the YES Network on channel 600. For a device to which settings of a first profile are applied, a schedule of programs may be generated for display indicating channels on which content may be received from a first content provider 105, but for another device to which settings of a second profile are applied, a schedule of programs may be generated for display indicating different channels on which the same content may be received from a second content provider 105, or may indicate different content which may be received. The server 100 may include a processor configured to respond to received profiles or profile updates, to store the received profile data in an accessible manner, and to provide the profile data to local content experiencing devices 115.

Local content experiencing devices 115 may include any processing device configured for receiving content and/or for displaying or otherwise outputting the received content. For example, the local content experiencing devices 115 may include a television or a computer in communication with a monitor. Any such processing device may be used in a system that implements an embodiment of the present invention by loading software onto the device, which when executed by the device causes the device to perform steps according to exemplary embodiments of the present invention. For example, the local content experiencing devices 115 may include a home TV 116, a hotel TV 117, and/or a computer 118. Each of the devices 115 may include a respective memory 111a-n. For example, the TVs 116-117 may each be in communication with a respective set-top box that includes the respective TV's memory 111a-b. The server 100's memory and the memories 111a-n may each include any combination of conventional memory circuits, including electrical, magnetic, and/or optical systems. They may include, for example, read only memory (ROM), random access memory (RAM), and/or bulk memory.

The memories 111a-n may include a respective hard-drive storage device 112a-n and may store a respective DVR software copy 120a-n execution of which causes a respective processor 113a-n to control storage of content in the respective hard-drive storage device 112a-n and to provide interactive menus to a user for managing the stored content and/or the storage of the content. The content may include broadcast programs, on-demand programs, digital data, streaming data, RSS feeds, audio data, video data, moving images, still images, etc. A non-exhaustive list of some of the file types of the content which may be received and/or stored at the local content experiencing devices 115 includes audio files, e.g., in a Waveform (WAV), Audio Interchange File Format (AIFF), Au, Windows Media Audio (WMA), MPEG-1 Audio Layer 3 (MP3), Vorbis, and/or Advanced Audio Coding (AAC) file format; still image files, e.g., in a Joint Photographic Experts Group (JPEG), Tagged Image File Format (TIFF), Portable Network Graphics (PNG), Graphic Interchange Format (GIF), bit mapped (BMP), WDP or HD Photo, X PixMap (XPM), Multi-resolution Seamless Image Database (MrSID), and/or Scalable Vector Graphics (SVG) file format, and/or RAW file formats; and moving image files, e.g., in a Audio Video Interleave (AVI), Windown Media Video (WMV), and/or QuickTime Movie (MOV) file format. The DVR software 120 may include Profile and Content Retrieval software 121 with pull technology for accessing, e.g., RSS feeds provided by podcasts 106 or other content hosts 108 or personal content stored at a content/profile manager 110, e.g., a computer. The content may be pulled, e.g., over a network such as the Internet. The local content experiencing devices 115 may also each include a respective TV tuner 125a-n for receiving programs broadcast, e.g., by a cable/satellite provider 105. For example, the TV tuners 125a-n may be in communication with an interface via which a cable signal may be input to the local content experiencing devices 115. The local content experiencing devices 115 may each include a respective monitor 127a-n for display of the received and/or stored content. One or more of the local content experiencing devices 115 may be provided without one or more of the components illustrated in FIG. 1 as being included in the devices 115. For example, a device that does not include a TV tuner 125 may be used as a local content experiencing device for experiencing content not received via a TV tuner, e.g., content received via the Internet.

Other local content experiencing devices 115 may include a mobile device such as a mobile telephone, such as a cell phone 120, personal digital assistant (PDA) 119, or a laptop computer. For example, the content/profile manager 110 may also be used as a local content experiencing device 115. Additionally, a single device may function as two or more of a local content experiencing device 115, the server 100, and the content/profile manager 110. Further, more than one device may function as the content/profile manager 110.

In one example embodiment, any local content experiencing device 115 may function as a content/profile manager as long as it has installed thereon software for performing functions for managing content and/or profiles. In one variant of this embodiment, all that is required for a local content experiencing device 115 to be used as a content/profile manager 110 is web browser software stored at the local content experiencing device 115 via which to connect to another device, e.g., the server 100, at which there is stored further software for execution of which, e.g., at the other device, to manage profiles and/or content associated with the profiles or otherwise associated with customer accounts into which the local content experiencing device 115 is logged. In another variant of this embodiment, some of the substantive software may be locally stored at the local content experiencing device 115 (used as the content/profile manager 110), while other of the substantive software may be remotely stored at another device. For example, software for locally storing personal content at the manager 110 (which may be transmitted to other local content experiencing devices 115) may be locally stored at the manager 110; software for setting profile and/or account preferences may be stored at the server 100.

Additionally, the server 100 may include a number of servers, each servicing a different sub-set of user profiles. The respective connections of each of the local content experiencing devices 115 (devices 116-120) to each of the content providers 102-108 may be wired or wireless. For example, FIG. 1 shows a wireless connection between the PDA 119/cell phone 120 to the content providers. The wireless connection can likewise be used for the other content experiencing devices 115.

Each of the processors of the server 100, content/profile manager 110, and local content experiencing devices 115 may be any one or combination of suitably appropriate processing systems, such as a microprocessor, a digital signal processor, and/or a field programmable logic array. The processing system may be embodied as any suitably appropriate computing device, e.g., a computer, personal digital assistant, laptop computer, notebook computer, or any device that can receive and/or send and store data.

A user profile may be associated with preferences in response to input by the user and/or in response to an automatic association created by a processor. For example, the user may input instructions indicating particular TV shows the user enjoys; particular TV show series, TV shows of which should be recorded whenever broadcast; content types the user enjoys viewing, such as “action,” “drama,” or “comedy”; and/or parental restrictions. A processor may automatically associate a user profile with probable user preferences the processor determines based on a recorded viewing history associated with the profile. For example, TV programs may be associated with metadata indicating the content type of the TV programs and/or actors acting in the TV programs. Over time, a pattern may be noticed, such as that 75% of viewed TV programs are comedies or feature a particular actor or one of a particular group of actors. Such patterns may indicate that viewers logged into the particular profile enjoy comedies or programs featuring the particular actor or one of the group of actors.

The user profiles may be additionally associated with preferences regarding content other than TV programs, e.g., a preference to receive feeds from particular podcasts, music from particular stations, or particular types of music.

Based on media content experience preferences associated with a user profile, suggestions for viewing or otherwise experiencing media content may be associated with and displayed for the user profile. For example, customized content menus and schedules may be displayed at a graphical user interface (GUI) of one of the local content experiencing devices 115 associated with the user profile, suggesting content to be experienced or recorded. Further, based on content recording instructions associated with a user profile, content may be stored at local content experiencing devices 115 in association with the user profile.

The local content experiencing devices may be in wired or wireless communication with the server 100 for logging into the profiles centrally stored at the server 100. For example, a user may enter a profile name, a username, and a password at a local content experiencing device 115 via an input device, e.g. a keyboard, mouse, or remote control. The information may be transmitted by the local content experiencing device 115 to the server 100. Responsive to receipt of the logging information, the server 100 may transmit profile information pertaining to the profile named in the received information sent to the requesting device 115. In response to receipt of the profile information, the settings of the profile may be applied to the requesting local content experiencing device 115. For example, upon receipt of the profile information, parental controls of the profile may be applied, customized profile scheduling information may be displayed, and/or recordings of received content to non-volatile memory may begin in accordance with a recording schedule associated with the user profile. Furthermore, the user may update the user profile at the local content experiencing device 115 and upload the updated profile data to the server 100 for storage in the database 100a. Accordingly, profile settings and preferences may be applied at any device 115 by logging into the centrally stored profile. Multiple ones of the local content experiencing devices 115 may log into and share a single profile. In one exemplary embodiment, the multiple devices 115 may simultaneously log into the profile.

When selecting a profile into which to log at a particular local content experiencing device 115, the user may take into consideration the content providers to which the particular local content experiencing device 115 is connected. For example, the home TV 116 may be serviced by a cable provider 105 and an office TV may be serviced by a satellite provider 105, so that different profiles (including different settings for providing a media content schedule of available media content, their airing times, and/or their channels) may be best suited for the different local content experiencing devices 115. Further, differences in types of content or channels on which content is provided may depend on the communications media for which the local content experiencing device 115 is configured to receive data, so that appropriate selection of profiles may depend on the particular communications media for which the local content experiencing device 115 is configured.

The local content experiencing devices 115 may further include storage devices for recording content according to a logged-in profile without providing functionality to experience, e.g., view or listen to, the content. (As referred to herein, recording content refers to storing a copy of the content, whether received in the form of a linear channel program broadcast, as a content download, e.g., over the Internet, or in any other manner.) For example, the storage device may be a portable device for docking at a second device that includes the functionality for outputting the content for the user to experience, e.g., according to the preferences of the profile of the storage device or according to another profile into which the user logs at the second device. The storage device may be used, e.g., for logging into the centrally stored profile, updating the centrally stored profile, and/or for recording content according to recording preferences and/or a recording schedule indicated by the profile into which the storage device has been logged.

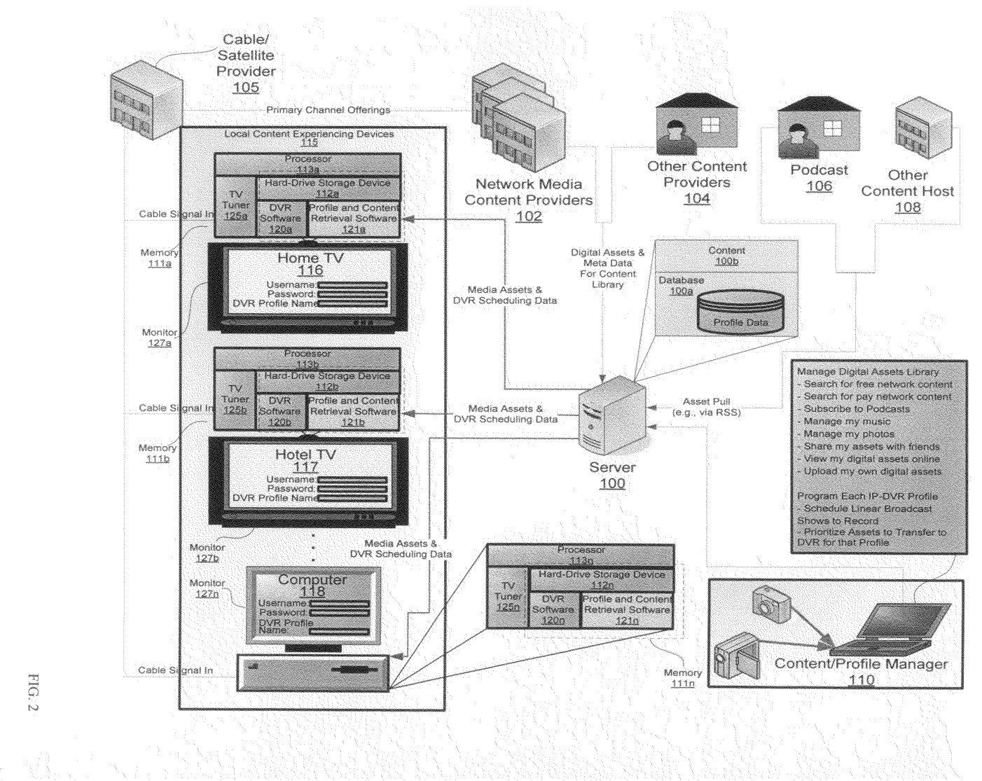

FIG. 2 illustrates components of a system according to an example embodiment of the present invention in which, besides for the profile data stored in the database 100a, the server 100 may centrally store content 100b for access by the local content experiencing devices 115. The server may function as a media content provider proxy server 100, which may centrally store different types of media content from a plurality of sources. For example, the server 100 may include a memory in which the server 100 stores media content 100b including TV programs received, e.g., in digital form over a network, such as the Internet, or via a tuner just as does a TV, from network media content providers 102; content received from other content providers 104; content provided via an asset pull, e.g., via an RSS feed, from podcast hosts 106 or other content hosts 108; and user content, such as a user's photos, music, videos, and/or other data, uploaded by the user's content/profile manager device 110. A non-exhaustive list of some of the file types of the content 100b stored at the server 100 (and/or eventually at the local content experiencing devices 115 as explained below) includes the file type list produced above with respect to FIG. 1. The server 100 may include a processor configured to respond to received content and/or pull content, to store the received and/or pulled content in an accessible manner, and to provide the content to the local content experiencing devices 115.

In one example embodiment of the present invention, the server 100 may be maintained by a content aggregation service provider for storing content for many customers, each having a different customer account. Alternatively, a separate server 100 may be provided for each customer account. For example, each customer may be provided with a personal server 100, which the customer may keep, e.g., at the customer's home.

With respect to the local content experiencing devices 115, which may be in wired or wireless communication with the server 100, the DVR software 120 may include Profile and Content Retrieval software 121 with pull technology for accessing the server 100 to retrieve content stored at the server 100, e.g., over a network such as the Internet or a local area network (LAN). The local content experiencing devices 115 may also each include a respective TV tuner 125a-n for receiving programs broadcast, e.g., by a cable/satellite provider 105. For example, the TV tuners 125a-n may be in communication with an interface via which a cable signal may be input to the local content experiencing devices 115. The local content experiencing devices 115 may each include a respective monitor 127a-n for display of the received and/or stored content. Other local content experiencing devices 115 may include a device for recording media content without providing functionality for experiencing the media content and/or a mobile device, such as a mobile telephone or a laptop computer. For example, the content/profile manager 110 may also be used as a local content experiencing device 115. Additionally, a single device may function as two or more of a local content experiencing device 115, the server 100, and the content/profile manager 110. Further, more than one device may function as the content/profile manager 110. Additionally, the server 100 may include a number of servers, each servicing a different sub-set of user profiles.

In an example embodiment of the present invention, content stored at the server 100 and/or at the local content experiencing devices 115 may be associated with user profiles. For example, a GUI may be provided at the local content experiencing devices 115, the content/profile manager 110, and/or the server 100 (e.g., where each customer is provided with a separate server 100 that the customer can physically access). The GUI may include display screens for creating, updating, and/or deleting the user profiles and for managing the association between the content and the user profiles. A user may interact with the GUI display screens via input devices, such as a keyboard, mouse, remote control, and/or any other suitably appropriate input device. A user profile may indicate content storing and viewing preferences. Preferences may be set manually and/or automatically, for example, for any of the file types listed above with respect to the content 100b. Based on content recording instructions associated with a user profile, content may be stored at the server 100 and/or at individual local content experiencing devices 115 in association with the user profile.

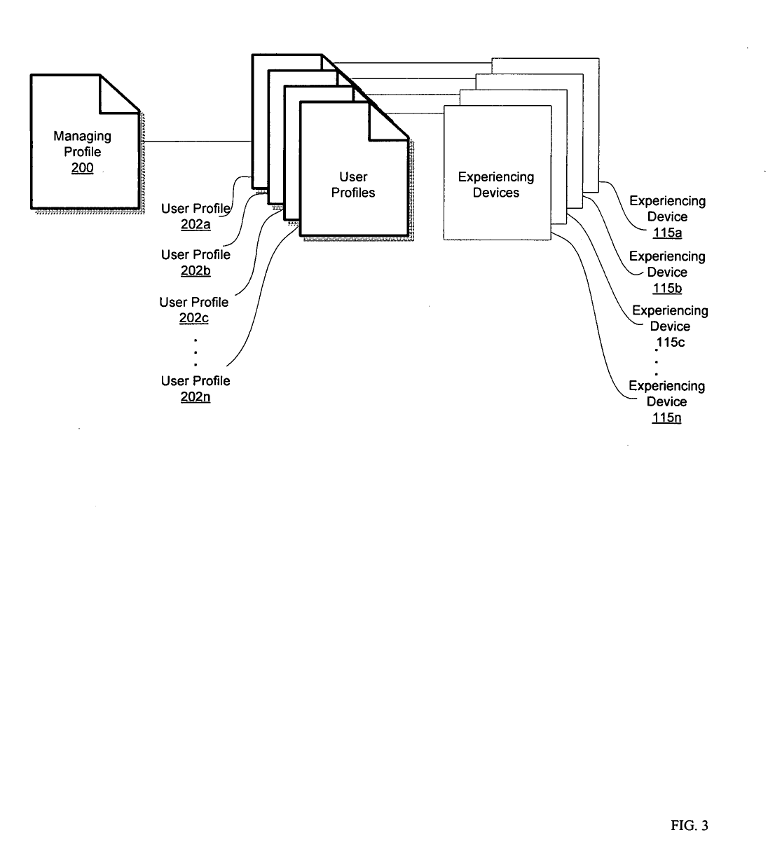

In an example embodiment of the present invention, a managing profile may be associated with a plurality of user profiles, as shown in FIG. 3. A user may access a managing profile 200 at the content/profile manager 110 to create, edit, and/or delete user profiles 202, and/or to associate particular user profiles 202a-n with particular local content experiencing devices 115a-n. Creation of and/or updates to the user profiles 202a-n performed in an environment of the managing profile 200 may be communicated in real time to the server 100, e.g., during a communication session between the content/profile manager 110 and the server 100 opened for the managing profile 200 into which the content/profile manager 110 has logged. Alternatively, after a user has entered all changes, the user may upload the modifications to the server 100. Although an association of a particular user profile 202 with a particular local content experiencing devices 115 may be made, a user profile 202 may be maintained even without associating the user profile 202 with any local content experiencing device 115. Even where a user profile 202 is not associated with any local content experiencing device 115, content may be stored for the user profile 202 at the server 100 for later viewing at a local content experiencing device 115 at which the user logs into the user profile 202. In one example embodiment of the present invention, a user profile 202 may be limited to an association with one local content experiencing device 115 at any one time. Such a limitation may be imposed by a content provider to ensure that a customer does not allow others to use the customer's profiles for viewing content not purchased by the others and/or to ensure that an intended device receives content recorded for the user profile (which might not be ensured if a plurality of local content experiencing devices 115 are configured to poll the server 100 for content associated with the same profile 202, as explained below). In an alternative example embodiment of the present invention, the user profile 202 may be simultaneously associated with a plurality of local content experiencing devices 115, for example, to allow a customer's family members to simultaneously enjoy benefits provided by application of preferences indicated by a user profile at different local content experiencing devices 115.

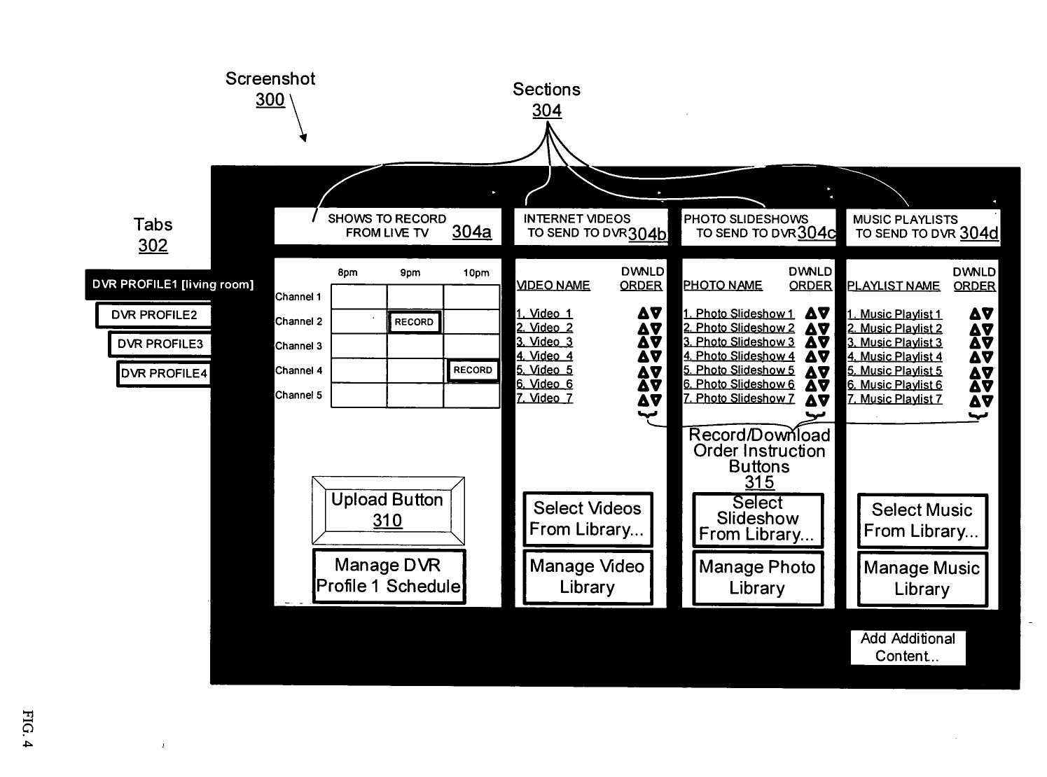

FIG. 4 is a screen shot 300 of a display that may be provided when a user logs a device into the managing profile 200, e.g., via the Internet. Tabs 302 may be displayed. Each tab 302 may correspond to and may be selected for managing a respective one of the plurality of user profiles 202. A blank tab may also be displayed for selection of which to create a new user profile. For each tab 302, the display area may be divided into columns or sections 304, each section 304 corresponding to a particular media content type. For example, a first section 304a may be provided for managing recording of broadcast TV programs, a second section 304b may be provided for managing downloading of internet videos, a third section 304c may be provided for managing photos, and a fourth section 304d may be provided for managing music playlists. The described sections 304 are exemplary; other sections 304 may be provided. Aside from providing for managing media content recording schedules, sections may be provided in the tabular display for indicating general preferences, such as content type favorites or parental restrictions. Buttons may be provided on the display for accessing additional menus. For example, a button may be provided to display a screen for managing parental controls.

In an example embodiment of the present invention, association of a profile 202 with a local content experiencing device 115 may be performed via the managing profile 200, e.g., regardless of the device at which a user has logged into the managing profile 200, e.g., remotely. For example, the user may input an Internet Protocol (IP) address of a particular local content experiencing device 115 with which to associate the user profile 202. In response to the association by the user of the local content experiencing device 115 with the profile 202, the device at which the user is logged into the managing profile 200 may contact the associated device 115 to inform the associated device 115 of the association. Alternatively, in response to a new device/profile association, the server 100 may contact the associated device 115 to inform the associated device 115 of the association. In one variant of this embodiment, if the associated device 115 is inaccessible, e.g., it is not powered up, the device at which the user is logged into the managing profile 200 and/or the server 100 may repeatedly attempt to access the associated device 115 until it is powered up. In accordance with the association of the profile 202 with the local content experiencing device 115, the local content experiencing device 115 may store content as specified by the user profile 202. Subsequent to the transmission of the notification of the association to the associated device 115, communications between the associated device 115 and the server 100 may be initiated by the associated device 115 polling the server 100 for updates to the profile 202 and/or available content. In one variant, further updates to the profile 202 may be transmitted by the content/profile manager 110 and/or server 100 to the associated device 115 in response to the profile update.

Alternatively or additionally, once a user inputs account information at a particular local content experiencing device 115, e.g., using the DVR software 120 at the local content experiencing device 115, to associate the local content experiencing device 115 with a particular account, the user may name the local content experiencing device 115 so that it may be identified when the user is subsequently logged into the managing profile 200 at any device. When the user sets up the local content experiencing device 115, the user profile information stored at the server database 100a may be updated to store the IP address of the local content experiencing device 115 and its associated nickname. Thereafter, when logged into the managing profile 200, the user may select the nickname of the local content experiencing device 115 to associate a user profile 202 with the local content experiencing device 115. For example, DVR Profile 1 for which attributes are displayed in the screen associated with the selected tab 302 of FIG. 4 is shown in the tab 302 to have been associated with a local content experiencing device 115 nicknamed “living room.”

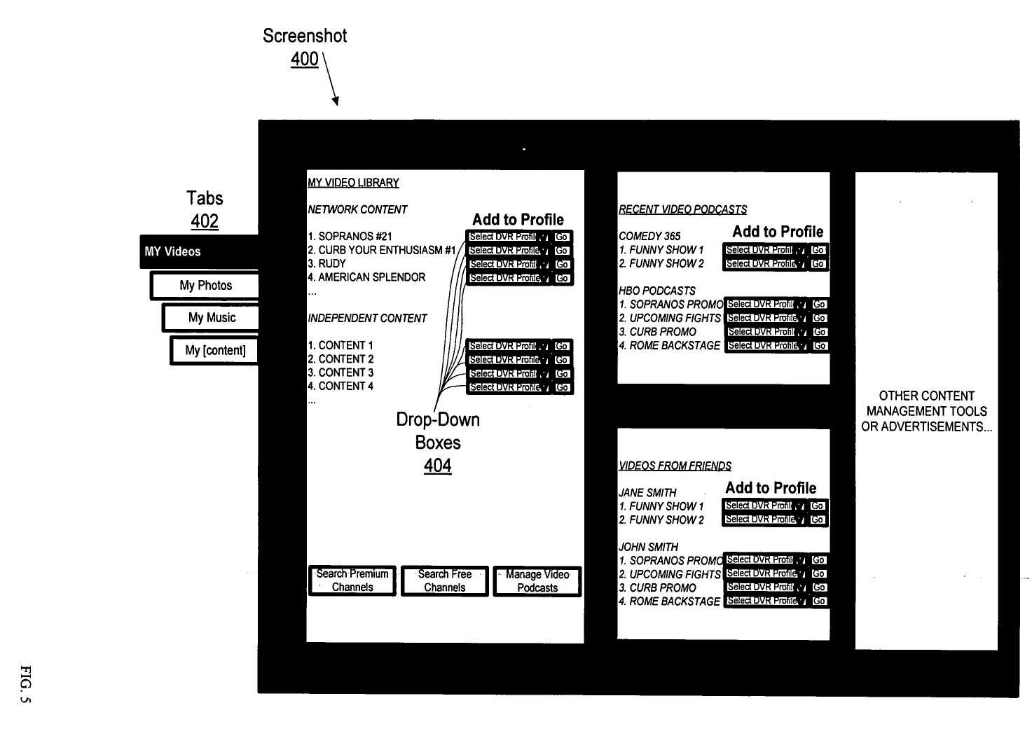

In an example embodiment of the present invention, different display views may be provided for managing content via the managing profile 200. For example, FIG. 5 is a screen shot 400 of another view that may be provided when logged into the managing profile 200. Tabs 402, each associated with a different media content type may be displayed. For each content listing displayed in a display provided for a particular content type, i.e., a particular selected tab 402, a drop down box 404 may be provided for selection of a particular profile with which to associate the content listing. After a content listing is associated with a particular profile, the content represented by the content listing may be stored at a local content experiencing device 115 associated with the particular profile.

In an example embodiment of the present invention, a local content experiencing device 115 may be associated with a user profile 202 by selection of the device nickname in the managing profile 200 or by logging into the particular user profile 202. For example, when a user checks into a hotel, the user may log into one of the user profiles 202 (or the managing profile 200) at the hotel TV 117. For example, the user may enter a username, password, and particular profile name of an existing user profile 202 set up at a different device. By logging into the user profile 202 at the hotel TV 117, the settings and preferences of the user profile 202 may be automatically applied to the hotel TV 117. In one variant of this embodiment, the settings of a user profile 202 may be applied to a particular local content experiencing device 115 for only as long as the local content experiencing device 115 remains logged into the user profile 115. Alternatively, at least some of the settings, e.g., regarding content to be downloaded to local storage, may continue to be applied to the local content experiencing device 115 until the user inputs an instruction to disassociate the local content experiencing device 115 from the user profile 202.

In an example embodiment of the present invention, in accordance with a user profile 202 with which a local content experiencing device 115 is associated, the local content experiencing device 115 may automatically record content received from the cable/satellite provider 105. For example, the user profile 202 may indicate that, during a particular time slot, content received from the cable/satellite provider 105 on a particular channel is to be recorded. The processor 113 of the local content experiencing device 115 may determine that a beginning time of the time slot has been reached by referencing a clock of the local content experiencing device 115. The processor 113 may tune the tuner 125 to the channel indicated by the user profile 202 to receive the content and may store it in the hard-drive storage device 112. Additionally, content 100b, e.g., any of the file types listed above with respect to the content 100b, stored at the server 100 and associated by the profile information stored in the database 100a of the server 100 with the user profile 202 with which the local content experiencing device 115 is also associated, may be automatically downloaded by the local content experiencing device 115 from the server 100 when the local content experiencing device 115 is logged into the user profile 202. Therefore, when a user logs into a user profile 202 at a local content experiencing device 115, the user need not select a particular content listing in which the user is interested for downloading the content in response to the selection, which would require the user to wait until the content is downloaded to view the content, since the content has already been downloaded as soon as the user logged into the local content experiencing device 115. (A wait may be required though if the user desires to experience content that has not been previously downloaded to the local content experiencing device 115 immediately after the user has logged into the user profile 202.) Additionally, because the content is automatically downloaded when the local content experiencing device 115 is logged into the user profile 202, the user is spared a sub-optimal content experience provided by streaming content.

The number of content items that may be stored at the server 100 or stored at a local content experiencing device 115 may be limited by the respective device's memory's storage capacity. Consequently, it may occur that less than all of the content items the user has instructed to be recorded for a user profile 202 are actually stored in the server 100 and/or ultimately in the local content experiencing device 115 associated with the user profile 202. Further, after a first content item is downloaded by the local content experiencing device 115 from the server 100, the user may open the content item at the local content experiencing device 115, e.g., to watch a movie, while the local content experiencing device continues to download additional content items from the server 100. Often, a user prefers particular content items or item groups over other content items or item groups. For example, a user may prefer television shows over audio files.

Accordingly, in an example embodiment of the present invention, the system and method may provide for input of instructions to indicate a preferred order of recording content at the server 100 and/or of downloading content by local content experiencing devices 115 from the server 100 for a user profile 202. For example, referring to FIG. 4, record/download order instruction buttons 315 may be displayed for selection of which to input a recording and/or downloading order preference for the content. Although, the buttons 315 illustrated in FIG. 4 are shown for ordering content items within particular content item groups (videos, photos, and playlists), additional buttons may be similarly provided for ordering the groups themselves, sub-groups of the content items within the shown groups, and/or particular content items spanning multiple ones of the shown groups. With respect to content stored at the server 100 for a particular user profile 202 for which an order has been input by the user, the server 100 may delete those content items indicated to be of less import than other content items (e.g., where first to download is considered to be of most importance) prior to deleting the other content items, e.g., where the server's used memory has reached its capacity and additional content, e.g., of greater importance than that of at least some of the previously stored content, is to be recorded. The local content experiencing device 115 may similarly delete its locally stored content in accordance with the indicated order preference. A difference between the logic used by the server 100 and the local content experiencing devices 115 in deleting content may be that the server 100 may generate its own order preference different than that of a particular user profile 202 depending on the number of user profiles 202 for which particular content listings are to recorded and/or by averaging the orders of the various user profiles 202 requesting the content. However, in one example embodiment of the present invention, a single local content experiencing device may be simultaneously associated with multiple user profiles 202, in which case the local content experiencing device 115 may manage its memory as may the server 100, by considering preferences of a combination of the user profiles 202 with which it is associated.

Aside from managing local memory of the local content experiencing device 115, the indicated record/download order may be used for controlling the order in which the local content experiencing device 115 downloads the content from the server 100. Accordingly, the user's favorite or most important content may be downloaded first so that the user may experience the favorite or important content while the local content experiencing device continues to download additional content from the server 100, i.e., the user need not wait until the local content experiencing device 15 downloads less desirable or important content before experiencing the more desirable or important content.

Alternatively and/or additionally, the system and method of the present invention may provide for input of instructions to assign particular content items and/or groups to preference grades, e.g., 5 star, 4 star, etc. Multiple content items may be assigned a same preference grade. Those content items assigned to higher preference grades than others may be downloaded before, and maintained in memory longer than, the others.

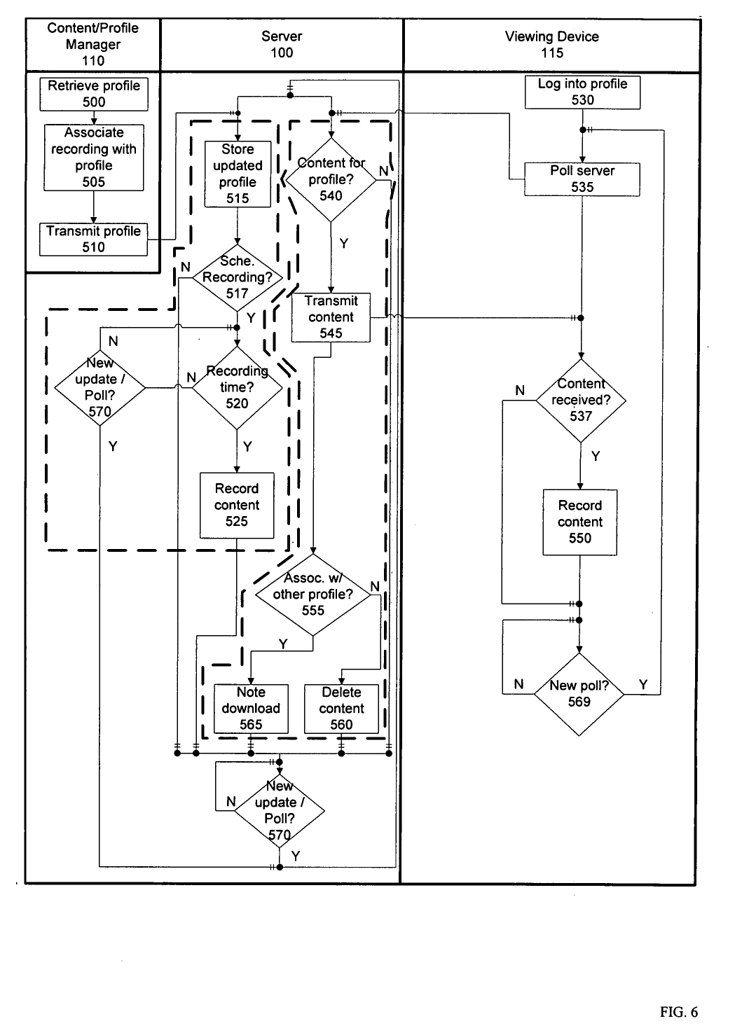

FIG. 6 is a cross-functional flowchart that illustrates a method that may be performed for recording content according to an example embodiment of the present invention. The particular steps and the particular sequence of steps are exemplary. Variations of the steps and/or their sequence shown in FIG. 6 may be implemented for managing content recordation, and, indeed, some variations are described below. A user may input a request at the content/profile manager 110 (of which form any local content experiencing device 115 may take) to log into the managing profile 200. While logged into the managing profile 200, the user may input an instruction to modify a user profile 202. Alternatively, the user may input a request to log directly into the user profile 202, bypassing the managing profile 200. In response, at 500, the content/profile manager 110 may retrieve the user profile 202 from the server 100. Responsive to an input by the user, e.g., via interaction with the displays of FIGS. 3 and 4, the content/profile manager 110 may, at 505, associate a content recording setting with the user profile 202. At 510, the content/profile manager 110 may transmit the updated user profile 202 to the server 100, which may, at 515, store the updated user profile 202. At 517, the server 100 may determine whether any of the profile information in the database 100a indicates that any recordings have been scheduled. If it is determined that there are no scheduled recordings, the server may, at 570, wait for a new user profile update or a new local content experiencing device poll. If, at 517, it is determined that there is at least one scheduled recording, for each scheduled recording, the server 100, referencing an internal clock, may, at 520, monitor whether the indicated recording time in the updated user profile 202 has been reached. Once the recording time has been reached, the server 100 may, at 525, begin recording of the content until an end of the content or an end of an indicated time slot has been reached.

In one example embodiment of the present invention, in response to receipt of the updated user profile 202, the server 100 may determine whether content newly indicated to be recorded is already included in the content 100b stored by the server 100. If the content is found in the content 100b, the server 100 may associate the already recorded content with the user profile 202 and omit performance of 520-525. Alternatively, the server 100 may perform 520 and associate the content with the user profile 202 when the indicated time is reached. The delay may be implemented so that the content is not prematurely deleted or indicated to have been downloaded from the user profile 202 at 560 or 565, respectively, in response to a poll from a local content experiencing device 115 at which the user did not intend the content to be locally stored, and is thereby not made available for download by an intended local content experiencing device 115.

The user may input data for logging a local content experiencing device 115 (which may be the content/profile manager 110) into the user profile 202 at 530. Responsive to the logging in, the local content experiencing device 115 may, at 535, e.g., periodically, poll the server 100 for content. Alternatively, the polling may be responsive to an explicit user instruction to poll or to begin polling. In an example embodiment of the present invention, the local content experiencing device 115 may continue the periodic polling of the server 100 even after the user logs the local content experiencing device 115 out of the user profile 202, e.g., and into another user profile 202. For example, the polling may be continued until a stop polling instruction or an instruction indicating a disassociation of the local content experiencing device 115 from the user profile 202 is received (or until the local content experiencing device 115 is powered down).

Responsive to a poll from the local content experiencing device 115, the server 100 may, at 540, determine whether the content 100b stored at the server 100 includes content associated for download with the user profile 202 for which the local content experiencing device 115 has polled the server 100. If no content associated for download with the user profile 202 is included in the content 100b, the server 100 may, at 570, continue to wait for another user profile update or poll. In one example embodiment of the present invention, the server 100 may transmit to the polling local content experiencing device 115 a message indicating that there is no content available. It is noted that even if the user profile 202 may indicate that content, e.g., content stored at the server 100, is associated with the user profile 202, the server 100 may determine that the content is not associated for download with the user profile 202, as explained below.

If content associated for download with the user profile 202 is included in the content 100b, the server 100 may, at 545, transmit the content associated for download with the user profile 202 to the local content experiencing device 115. The local content experiencing device 115 may, at 537, determine whether content has been received. After a predetermined time interval from the time of the poll, which may be determined to have elapsed at 569, the local content experiencing device 115 may poll the server 100 again. If, within the time interval, the local content experiencing device 115 determines at 537 that content has been received, the local content experiencing device 115 may, at 550, locally record the received content.

After transmitting the content at 545, the server 100 may, at 555, determine based on the profile information of the database 100a and/or metadata associated with the content 100b whether the transmitted content is also associated with another user profile 202. If the content is not associated with another user profile 202, the server 100 may, at 560, delete the content from the content 100b. Otherwise, the server 100 may, at 565, note the download of the content with respect to the user profile 202 for which the local content experiencing device 115 polled the server 100. For example, for each content of the content 100b the server 100 may store metadata listing the user profiles 202 with which the content is associated and indicating for each of the listed user profiles 202 whether the content has been downloaded for the respective user profile 202, e.g., via a value of a bit. Alternatively, the metadata may indicate the profiles 202 for which the content is to be downloaded. After the content is downloaded for one of the profiles 202, the profile 202 may be removed from the list of profiles 202 for which download of the content is to be performed. In one example embodiment of the present invention, if content stored at the server 100 is associated for download with a profile 202 for which no local content experiencing device 115 polls the server 100 for a long period of time, the server 100 may delete the content when a maximum storage space is met and additional content to be recorded is available for recording at the server 100. That is, for determining which of the previously recorded content is to be deleted (if any), weightings may be applied to the different previously recorded content to determine which content is least valuable. That content has been stored for a profile 202 for a long period of time may be used by the server 100 as criteria for applying an associated weight factor for deleting the content. If after a long period of time of storing the content for a particular user profile 202, the same content is associated with another user profile 202, the new association may restart the time period considered for applying the weighting factor.

When determining, at 540, whether the content 100b includes content associated with the user profile 202 for which the local content experiencing device 115 has polled the server 100, the server 100 may determine whether the content associated with the user profile 202 has already been downloaded for the user profile 202, e.g., by referencing the metadata bit value. If the only content of the content 100b that is associated with the user profile 202 is content that has already been downloaded for the user profile 202, the server 100 may determine at 540 that there is no content associated for download with the user profile 202. At 545, the server 100 may refrain from transmitting to the local content experiencing device 115 content of the content 100b that is associated with the user profile 202 but that has already been downloaded for the user profile 202.

In an alternative example embodiment of the present invention, the server 100 may continue to store in the content 100b content for which metadata indicates that the content has been downloaded for all profiles with which the content is associated, until a maximum storage space is met and additional content to be recorded is available for recording at the server 100. That the content has been downloaded for all profiles with which the content is associated may be considered for applying a weighting factor when determining which content to delete.

As explained above, the server 100 may also function as a local content experiencing device 115. According to this embodiment, for any content stored at the server 100 for a user profile 202 with which the server 100/local content experiencing device 115 is associated, the server 100 may omit 555-565 when another local content experiencing device 115 polls the server 100 for content available for the user profile with which the server 100 is associated. According to this embodiment, the server 100 may store a record of each device to which the server 100 transmitted the content stored at the server 100 for the user profile 202 with which the server 100 is itself associated. When a local content experiencing device 115 polls the server 100 for content for the user profile 202 with which the server 100 is also associated, the server 100 may, at 540, determine that the content is not available for transmission to the requesting local content experiencing device 115 if the server 100 stores a record indicating that the content had been previously transmitted to the requesting local content experiencing device 115. The record may be reset if a new record instruction for the content that had been previously transmitted to the local content experiencing device 115 is received for the user profile 202, e.g., in the case of a rerun broadcast. In an alternative embodiment, the local content experiencing device 115, when polling the server 100, may transmit a list of its locally stored content so that the server 100 may determine whether any content associated with the user profile 202 for which the local content experiencing device 115 has polled the server 100 has already been locally stored at the local content experiencing device 115, as explained below. In an alternative embodiment of the present invention, the local content experiencing device 115 may determine whether the content available at the server 100 is already locally stored at the local content experiencing device 115, as explained below.

In one example embodiment of the present invention, during the log-in into the user profile 202 by the local content experiencing device 115, the local content experiencing device 115 may communicate with the server 100 during which communication the server 100 may transmit the updated user profile 202 to the local content experiencing device 115. The preferences indicated by the user profile 202 may be applied to the local content experiencing device 115 when the updated user profile 202 is received. In one example embodiment, the server 100 may periodically send the user profile 202 to ensure that any updates to the user profile 202 are applied to the local content experiencing device 115. For example, the user profile 202 may be transmitted to the local content experiencing device 115 in response to each poll by the local content experiencing device 115 at 535. Alternatively, or additionally, the server 100 or the content/profile manager 110 (or another local content experiencing device 115 logged into or managing the user profile 202) may transmit the user profile 202 to the local content experiencing device 115 in response to an update to the user profile 202. If no local content experiencing device 115 is associated with the updated user profile 202 at the time of the update, transmission of the updated user profile 202 to a local content experiencing device 115 may be omitted until an association is established.

In an example embodiment of the present invention, in response to the updated user profile 202 received by the local content experiencing device 115 in response to the poll, the local content experiencing device 115 may determine with respect to each content listing associated with the user profile 202 and for which the recording time has already passed, whether the content has been locally stored at the local content experiencing device 115. If the local content experiencing device 115 determines that the content listing has not been locally stored, the local content experiencing device 115 may request the content of the content listing from the server 100; otherwise, the local content experiencing device 115 may refrain from requesting the content of the content listing. Responsive to the list of requested content received from the local content experiencing device 115, the server 100 may, at 540, determine whether the content 100b of the server 100 includes the requested content. Accordingly, if the metadata stored at the server 100 indicates that content stored at the server 100 is not available for the user profile 202 (but rather, for example, for another user profile 202), the local content experiencing device 115 may nevertheless receive the content as long as it is still stored at the server 100. It may occur that the server 100 does not include the requested content if it has already been downloaded for all user profiles 202 with which the content had been associated, including the user profile 202 with which the requesting local content experiencing device 115 is associated, for example, where the content was downloaded by another local content experiencing device 115 associated with the same user profile 202. Alternatively, instead of sending the request for the content to the server 100 for the server 100 to make the determination of availability of the content at the server 100, the server 100 may additionally provide the local content experiencing device 115 with the content metadata or data of the database 100a so that the local content experiencing device 115 may make the determination as to whether the content is available at the server 100.

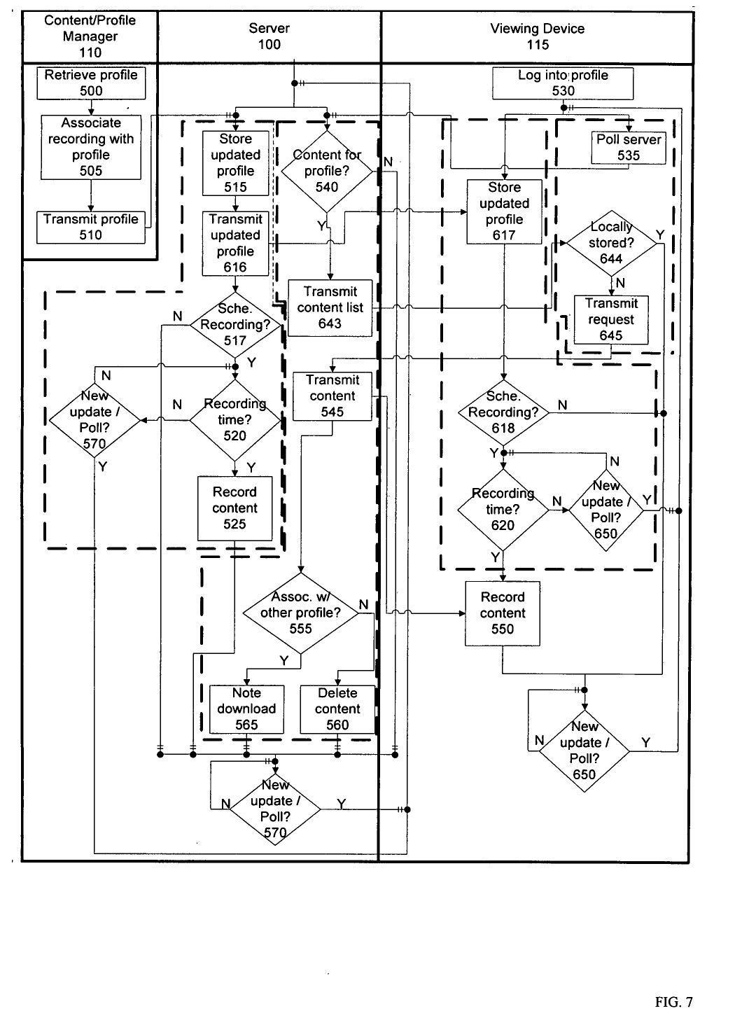

FIG. 7 is a cross-functional flowchart that illustrates a method that may be performed for recording content according to an alternative example embodiment of the present invention. Steps illustrated in both FIG. 6 and FIG. 7 are labeled with like reference numbers. Repetition of the discussion above of some of the steps common to both FIG. 6 and FIG. 7 is omitted. The particular steps and the particular sequence of steps of FIG. 7 are exemplary. Variations of the steps and/or their sequence shown in FIG. 7 may be implemented for managing content recordation, and, indeed, some variations are described below. According to this embodiment, content broadcast, e.g., on a linear broadcast channel, to all local content experiencing devices 115 that include a TV tuner 125, e.g., by the cable/satellite provider 105, are directly recorded by the local content experiencing devices 115 in each local content experiencing device 115 's respective local storage 112 since the content is received by the local content experiencing device 115 in any case.

After update of the user profile 202, the server 100 may, at 616, transmit the updated user profile 202 to the local content experiencing device(s) 115 associated with the updated user profile 202. (Alternatively, the server 100 may transmit the updated user profile 202 in response to a poll performed at 535 by the local content experiencing device 115). Responsive to receipt of the updated user profile 202, the local content experiencing device 115 may, at 617, store a local copy of the updated user profile 202 in the memory 111 of the local content experiencing device 115.

In one exemplary embodiment, the profile 202 may be stored at 617 in non-volatile memory so that the profile preferences or a portion thereof may be immediately applied to the local content experiencing device 115 each time the local content experiencing device 115 is powered up, e.g., even without logging into the profile 202. For example, the local content experiencing device 115 may record content according to a recording schedule of the user profile 202 upon powering up, even without logging into the profile 202. After a user logs the local content experiencing device 115 into the user profile 202, the local content experiencing device 115 may retrieve another copy of the user profile 202 from the server 100 and overwrite the locally stored copy with the new copy to apply updates to the user profile 202, if any.

In an alternative example embodiment of the present invention, the local content experiencing device 115 may store the local copy of the user profile 202 in volatile memory. The local content experiencing device 115 may store in non-volatile memory logging information for logging into the user profile 202 and may automatically retrieve from the server 100 updated recording schedules of the user profile 202 upon power up of the local content experiencing device 115.

Based on information of the received user profile 202, the local content experiencing device 115 may, at 618, determine whether any broadcast content from the cable/satellite provider 105 is scheduled to be recorded for the received user profile 202. If none is scheduled, the local content experiencing device 115 may, at 650, wait for a new user profile update or polling event in response to which the local content experiencing device 115 may perform either 617 or 535. Otherwise, the local content experiencing device 115 may, at 620, wait for the scheduled recording time and, at 650, for a new user profile update or polling event. When the local content experiencing device 115, referencing its internal clock, determines that the recording time has arrived, the local content experiencing device 115 may, at 550, tune its tuner 125 to the channel on which the content is broadcasting and record the broadcast content for storage in its hard-drive storage device 112. The local content experiencing device 115 may then, at 650, wait for a new user profile update or polling event.

A polling event may be a lapse of a predetermined time interval, a user instruction, a log-in into the user profile 202, and/or a power up of the local content experiencing device 115 (e.g., after the local content experiencing device 115 has received an indication of its association with the user profile 202). Responsive to the polling event, the local content experiencing device 115 may, at 535, poll the server 100 for content remotely stored at the server 100 for the user profile 202 (and/or for a user profile update). If the server 100 determines, at 540, that content stored at the server 100 is associated with the user profile 202 for which the server 100 has been polled, the server 100 may, at 643, generate and transmit to the local content experiencing device 115 a content list of all content available at the server 100 for the user profile 202.

Alternatively, in response to the poll 535, the server 100 may transmit an updated profile and data indicating all content stored at the server 100 (e.g., including content stored for other user profiles 202 that are not the subject of the poll). The local content experiencing device 115 may then determine which of the content associated with the profile 202 for which the local content experiencing device 115 polled the server 100 is still stored at the server 100.

At 644, the local content experiencing device 115 may determine for each listed content that is also associated with the user profile 202 for which the user device 115 polled the server 100 (e.g., even if not associated for download with the user profile 202) whether the content is already locally stored at the local content experiencing device 115. For example, the content may be a rerun that had been previously recorded and transmitted to the local content experiencing device 115 by the server 100 or may have been previously sent as a broadcast for local recordation by the local content experiencing device 115.

Further, in one example embodiment of the present invention, the server 100 may omit recordation of content broadcasts if one or more local content experiencing devices 115 are associated with the user profile 202 since the local content experiencing devices 115 may record the broadcast content. The system and method of the present invention may, however, provide that if a user profile 202 for which broadcast content is scheduled to be recorded is not associated with any local content experiencing device 115, the server 100 may record the broadcast content so that it may be provided to a local content experiencing device 115 after association of the user profile 202 with the local content experiencing device 115.

In an alternative example embodiment of the present invention, the server 100 may record content broadcasts even though the local content experiencing devices 115 associated with the user profile 202 may be configured to simultaneously record the broadcast content. Such simultaneous recordation may be advantageous since recordation of the broadcast content at the server 100 may make the broadcast content available to additional local content experiencing devices 115 the user associates with the user profile 202 after the broadcast. According to the latter embodiment, if the local content experiencing device 115 was powered and already associated with the user profile 202 at the time of broadcast, the content would have been recorded at both the local content experiencing device 115 and the server 100. The local content experiencing device 115 may therefore determine at 644 that the content list includes a listing that had already been locally stored, i.e., the listing of the content simultaneously recorded by the server 100 and the local content experiencing device 115.

After determining all items of the content list that have not been locally stored, if any, the local content experiencing device 115 may, at 645, transmit a request to the server 100 for the non-locally stored content. Responsive to the request, the server 100 may, at 545, transmit the requested content to the local content experiencing device 115. The local content experiencing device 115 may, at 550, record the content received from the server 100.

After transmitting the content to the local content experiencing device 115, the server 100 may perform 555-570 for all content associated with the user profile 202 for which the local content experiencing device 115 polled the server 100, even the content that was not transmitted to the local content experiencing device 115 since it had already been locally stored at the local content experiencing device 115 and therefore not been included in the request transmitted at 645. As explained above with respect to FIG. 6, some embodiments of the present invention may provide for keeping the content stored at the server 100 until all memory space allocated to the content 100b of the server 100 has been filled and additional space is required. Further, the server 100 may also be a local content experiencing device 115 associated with a user profile 202 for which content is stored at the server 100. According to this embodiment, the content may be immediately indicated as having been downloaded for the user profile 202 with which the server 100 is associated, since as soon as it is recorded at the server 100 it is also stored at a local content experiencing device 115 associated with the user profile 202 for which the content is recorded, i.e., the server 100. Nevertheless, since the server 100 is associated with the user profile 202 for which the content was recorded and therefore maintains a local copy of the content at the server 100, should another local content experiencing device 115 associated with the same user profile 202 determine that content not locally stored at the local content experiencing device 115 is associated with the user profile 202 and accordingly request the content at 645, the server 100 may transmit the content at 545. According to this embodiment, if the server 100 is polled for a user profile 202 with which the server 100 is associated, instead of transmitting a content list at 643, the server 100 may transmit the updated profile along with an indication of all content stored at the server 100, as explained above.

After content is stored locally at a local content experiencing device 115 for a particular user profile 202, it may be desirable to make the content available for download by another local content experiencing device 115 already associated or that will be associated with the same user profile 202. For example, a user may enjoy application of preferences, including recording preferences, of a particular user profile 202. The user may associate the user's home TV 116 with the user profile 202. While associated with the user profile 202 and while powered, the home TV 116 may download content associated with the user profile 202 from the server 100. The user may shortly thereafter, for example, prior to viewing the content, leave on vacation to a hotel at which the hotel TV 117 is located. The user may wish to view at the hotel TV 117 the content, e.g., the unviewed and recently downloaded content, locally stored at the home TV 116.

In an example embodiment, the system and method of the present invention may provide for input of an instruction to upload content stored at a local content experiencing device 115 to the server 100 for association with one or more user profiles 202. For example, a GUI button 310 (illustrated in FIG. 4) may be displayed in a profile management screen, e.g., of the managing profile 200 and/or of a user profile 202, for input of the upload instruction. A button 310 may be provided next to each listed content item. Alternatively or additionally, a single button may be provided with a selection field, e.g., a drop-down box, via which to indicate which content stored for the user profile 202 (if the button 310 is selected within a display of the user profile 202) to upload. One option, e.g., provided for the single button 310 that does not correspond specifically with any one particular listed content item, may be “all” to indicate that all content locally stored for the user profile 202 should be uploaded to the server 100.

Another selection field, e.g., a drop-down box, may be provided for indicating particular profiles 202 with which the selected content is to be newly associated. The user may optionally create a new user profile 202, e.g., to be eventually associated with the hotel TV 117, prior to entering the upload instructions, and then select the newly created profile 202 as the profile 202 with which the uploaded content is to be associated. In one example embodiment, the system and method of the present invention may provide for copying an existing profile 202 as a new profile 202. This may be beneficial where the user desires to apply all of the preferences of the user profile 202 to two different local content experiencing devices 115 and desires to have all of the content to be stored for the user profile 202 at both of the local content experiencing devices 115. When selecting the button 310 within a display screen of a particular user profile 202, the particular user profile 202 may be a default selection. For example, if the submit button is selected without indicating a user profile preference, the system and method may execute the upload for the particular user profile 202. Similarly, within the drop-down box, the particular user profile 202 may be the first listed option and/or may be the initially highlighted option. If the content is uploaded from a local content experiencing device 115 for association with the user profile 202 with which the local content experiencing device 115 is associated, the content may be once again stored in the server 100 in association with the user profile 202 with which the local content experiencing device 115 from which the content was uploaded is associated.

The system and method may provide for selectively indicating more than one particular user profile 202 with which to associate the content item. For example, after selecting one user profile 202 from a first drop-down box, the system and method of the present invention may display another drop-down box including a list of all non-selected user profiles. After each selection, another drop-down box may be displayed until the user finally selects the submit button. In one example embodiment of the present invention, when selecting the button 310, the system and method may successively provide a plurality of pages via which to enter different options regarding the upload until the user selects the submit button.

When the user submits the upload instruction indicating which content to upload, the local content experiencing device 115 may upload the selected content to the server 100 which may, in turn, interpret the upload as a new scheduled recording associated with the user profile 202 with which the submission was associated. If the upload is set to occur without any delay, the server 100 may, at 520 (with reference to FIGS. 5 and 6), determine that the recording time has arrived and record the content at 525. In the case where the content is uploaded for a user profile 202 with which a local content experiencing device 115 from which the content was uploaded is associated, e.g., the home TV 116, it may occur that the content will only be available for download by another local content experiencing device 115 associated with the user profile, e.g., the hotel TV 117, if the home TV 116 does not first poll the server 100 for content. (As explained above, in some instances the content may remain available for the hotel TV 117 even if the home TV 116 is the first to poll the server 100 for content after the upload.) The user may input an instruction to the home TV 116 to refrain from polling the server 100 for content (or, in another embodiment, may refrain from inputting an instruction at the home TV 116 to poll the server 100 for content). Alternatively, the user 100 may power down the home TV 116, log the home TV 116 out of the user profile 202, or disassociate the home TV 116 from the user profile 202.

Accordingly, example embodiments of the present invention provide that a user may log into any user profile 202 at any local content experiencing device 115 to have the profile preferences of the user profile 202, including recording preferences, applied to the local content experiencing device 115. Further, content recorded for a user profile 202 may be accessed for download by any local content experiencing device 115 at which the user logs into the user profile 202 or with which the user associates the user profile 202. The content may be downloaded without requiring selection at the local content experiencing device 115 of particular content items to be downloaded to the local content experiencing device 115. Instead, numerous content items may be downloaded to the local content experiencing device 115 by the mere association of the local content experiencing device 115 with, or the logging into, the user profile 202. Further, content locally stored at any local content experiencing device 115 may be made available for download in the above indicated manner to any other local content experiencing device 115. Further, the content may be made available to the other local content experiencing devices 115 without requiring selection of each particular content item the user desires to be available at the other local content experiencing device 115. Instead, the user may instruct that all content associated with a user profile 202 is to be made available, in response to which the content of the user profile 202 may be uploaded to the server 100 for download by the other local content experiencing devices 115.

In one example embodiment of the present invention, an entity may provide a service of setting up and maintaining various user profiles made available to the entity's customers for subscription thereto. Such a service may spare the entity's customers the burden of setting up user profiles. When a customer purchases a subscription to a profile, the entity may generate a copy of the profile with which the customer may associate one or more of the customer's local content experiencing devices 115, e.g., by logging into the profile at the customer's local content experiencing device 115. Content may be stored in accordance with the profile copy at a server 100 of the entity, a server 100 of the customer, or a server 100 servicing a plurality of accounts including the entity's and the customer's accounts. The profile copies may be associated with the customers' accounts or with the entity. In the latter scenario, for example, the entity may cancel the profile, e.g., by invalidating the log-in information or deleting the profile copy, upon termination of the subscription.

Those skilled in the art can appreciate from the foregoing description that the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A method for recording content, comprising:
in accordance with a recording schedule of a profile:
storing content at a server; and
storing an association of the content with the profile at the server; and
responsive to a content request from a first device associated with the profile:
determining by the server which content stored at the server is associated with the profile; and
transmitting by the server a copy of the content that has been determined during the determining step to be associated with the profile to the first device.

2. The method of claim 1, further comprising:
transmitting the content request by the first device at least one of at predetermined intervals and in response to at least one predetermined event.

3. The method of claim 2, further comprising:
associating the first device with the profile;
wherein the first device transmits the content request in response to a first one of the at least one predetermined event, and the first predetermined event is a provision to the first device of an indication of the performance of the associating.

4. The method of claim 3, wherein the associating and the provision of the indication are performed by logging into the profile at the first device.

5. The method of claim 3, wherein the first device transmits the content request in response to a second one of the at least one predetermined event, and the second predetermined event is a power-up of the first device after the association of the first device with the profile.

6. The method of claim 1, wherein the server records a single copy of a particular content for each of a plurality of profiles that each indicates that the particular content is to be recorded.

7. The method of claim 6, further comprising:
associating the single copy of the particular content with each of the plurality of profiles.

8. The method of claim 7, further comprising:
storing tracking information indicating for which of the plurality of profiles to which a respective copy of the single copy is to be provided;
for each of the plurality of profiles to which the respective copies are to be provided, updating the tracking information to indicate that the respective copy has been provided in response to transmission of the respective copy to at least one device associated with the respective profile;
from the tracking information, determining whether any profile remains to which a respective copy of the single copy is yet to be provided; and
deleting the single copy from the server responsive to a determination that the respective copies of all of the plurality of profiles have been provided.

9. The method of claim 8, wherein the server is associated with at least one of the plurality of profiles, and, because of the association of the server with the at least one of the plurality of profiles, the tracking information maintains an indication that the single copy is to remain stored at the server for one of the at least one plurality of profiles even after the server transmits the respective copy of the single copy for the one of the at least one plurality of profiles.

10. The method of claim 1, further comprising:
determining whether the content that is stored at the server and that has been determined during the determining step to be associated with the profile has also been stored at the first device;
wherein the copy is transmitted conditional upon a determination that the content that is stored at the server and that has been determined during the determining step to be associated with the profile has not been stored at the first device.

11. The method of claim 10, further comprising:
responsive to receipt from a content provider and by the first device of broadcast content indicated by the recording schedule to be recorded, storing the received content at the first device.

12. The method of claim 1, further comprising:
transmitting the content from a second device to the server; and
transmitting from the second device to the server an instruction updating the recording schedule and indicating that the content transmitted by the second device is to be associated with the profile, the storing of the content and the association at the server being in accordance with the instruction.

13. The method of claim 12, wherein the profile is not associated with any device when the instruction is transmitted.

14. The method of claim 1, wherein the content stored at the server includes a moving image received by the server via a television tuner.

15. The method of claim 14, wherein the content further includes an audio file, a still image file, and content of an RSS feed.

16. A method for managing recording of content, comprising:
logging into a first profile;
setting a recording preference for a second profile, the logging into the first profile providing access to perform the setting; and
subsequent to the setting, logging into the second profile at a device to apply the recording preferences of the second profile at the device.

17. A method for recording content, comprising:
at a first device, creating a user profile including a recording schedule and unassociated with any device;
transmitting the user profile to a server; and
logging into the user profile at one of the first device and a second device to associate the one of the first device and the second device with the user profile;
wherein:
the one of the first device and the second device is configured to, responsive to the association of the one of the first device and the second device with the user profile, poll the server for content stored at the server in association with the user profile; and
the server is configured to:
store content in association with the user profile in accordance with the recording schedule; and
transmit the stored content to the one of the first device and the second device in response to a poll from the one of the first device and the second device.

18. A computer-readable medium having stored thereon instructions adapted to be executed by a processor, the instructions which, when executed, cause the processor to perform a method for recording content, the method comprising:
in accordance with at least one profile's recording schedule:
storing content; and
storing associations of respective portions of the content with respective ones of the at least one profile;
responsive to a content request from a device associated with a particular one of the at least one profile, determining which of the stored content is associated with the particular profile; and
transmitting a copy of the content determined during the determining step to be associated with the particular profile to the device.

19. A system for recording content, comprising:
a content experiencing device associated with a profile; and
a server;
wherein:
the content experiencing device is configured to transmit a content request to the server; and
the server is configured to:
in accordance with a recording schedule of the profile:
store content; and
store an association of the content with the profile; and responsive to the content request:
determine which content stored at the server is associated with the profile; and
transmit to the content experiencing device a copy of the content that has been determined during the determining step to be associated with the profile.

20. The system of claim 19, wherein the content experiencing device is associated with a plurality of profiles in association with which the server stores content.

21. The system of claim 19, wherein the content experiencing device is associated with the profile by logging into the profile at the content experiencing device.

22. The system of claim 21, wherein the content experiencing device includes:
a television;
a set-top box; and
a memory for storing the copy of the content.

23. The system of claim 22, wherein the server includes:
a television;
a set-top box; and
a memory in which the content and the association of the content with the profile is stored.

24. The system of claim 23, wherein:
the server's memory stores a plurality of profiles including the profile with which the content experiencing device is associated; and
for logging into the profile:
the content experiencing device is configured to transmit user input profile information to the server; and
the server is configured to:
determine whether the user input profile information matches corresponding information of the profile stored in the server's memory; and
conditional upon that the server determines that the user input profile information matches the corresponding information, transmit data to the content experiencing device for opening a profile session at the content experiencing device during which the content experiencing device transmits the content request in association with the profile.

25. A display method for managing content, comprising:
displaying a user-interactive screen for a managing profile, wherein:
the managing profile includes information that regards a media management customer account and that is updatable by user interaction with screens including the user-interactive screen displayed for the managing profile; and
the user-interactive screen includes:
a plurality of first tabs, each of the first tabs associated with a respective one of a plurality of user media preference profiles, and one of the first tabs being an active tab; and
for the active tab:
a listing of at least one of recording preferences and recorded content associated with the user media preference profile of the active tab, the listing updatable by user interaction with the listing; and
an input field for user input indicating one or more recording devices to be associated with the user media preference profile of the active tab.

26. The display method of claim 25, wherein the user-interactive screen further includes a second tab, selection of which is interpreted by a processor as an instruction to generate a new media preference profile.

27. The display method of claim 25, wherein at least one of the user-interactive screen and a second screen displayed in response to selection of a sub-menu of the user media preference profile of the active tab includes for the active tab a selectable graphical unit, selection of which is interpreted by a processor as an instruction to upload locally stored content to a server for storage at the server in association with one of the plurality of user media preference profiles.

28. The display method of claim 25, wherein:
the listing includes a plurality of sub-listings, each sub-listing being of a respective one of a plurality of media content types; and
each of the plurality of sub-listings is separately displayed in the user-interactive screen.

29. The display method of claim 28, wherein the plurality of media content types includes at least two of a video content type, an audio content type, and a still image content type.

30. A method for applying a media content profile to devices, comprising:
for a single profile stored at a central storage device and including at least one media content setting, each of a plurality of devices:
transmitting log-in information associated with the profile; and
responsive to receipt of information transmitted by the central storage device in response to the transmitted log-in information, applying to the device a media content setting of the profile indicated in the received information.

31. The method of claim 30, wherein the at least one media content setting includes at least one of a parental control, a recording preference, a media content experience preference, a media content provider setting, and a communications medium setting.

32. The method of claim 30, further comprising:
each of the plurality of devices scheduling a time for recording media content based on the media content setting.

33. The method of claim 30, further comprising:
at least one of the plurality of devices:
while logged into the profile, requesting the central storage device to determine which media content is stored at the central storage device in association with the profile and to transmit to the requesting device at least a portion of the determined media content, the portion including all of the determined media content that is not stored at the requesting device at the time of the request; and
storing at the requesting device all media content received from the central storage device in response to the request.

34. A method, comprising:
storing at a central storage device a profile including at least one media content setting; and
for application of the at least one content setting to each of a plurality of accessing devices that accesses the central storage location for logging into the profile, transmitting the at least one media content setting to each of the plurality of accessing devices in response to the logging into the profile by the accessing device.

35. The method of claim 34, further comprising:
at least one of the plurality of accessing devices periodically polling the central storage location for updates to the profile.

36. A method of sharing a profile by a plurality of devices, comprising:
storing, at a central location, a profile, the profile including device settings of a user;
accessing, by a first one of the plurality of devices, the profile;
recording content by the first one of the plurality of devices as a function of the profile;
accessing, by a second one of the plurality of devices, the profile; and
recording content by the second one of the plurality of devices as a function of the profile.

37. The method of claim 36, wherein the central location is at a location that is remote to both the first and second ones of the plurality of devices.
